(19) United States
(12) Patent Application Publication
(10) Pub. No.: US 2010/0133966 A1
(43) Pub. Date: Jun. 3, 2010

(54) APPLIANCE

(76) Inventor: DRAGOS MURGUREL BLAGA, DUNEDIN (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/624,952

(22) Filed: Nov. 24, 2009

Related U.S. Application Data
(60) Provisional application No. 61/118,574, filed on Nov. 28, 2008.

(51) Int. Cl. A47B 81/00; E06B 7/16; B23P 11/00

(52) U.S. Cl. 312/242; 49/475.1; 29/525.01

(57) ABSTRACT

An appliance such as a refrigerator, dishwasher or other appliance, is adapted to be installed within a kitchen or cabinet space. The appliance has a chassis with two side members, a top member and a bottom member. The side members are spaced apart and parallel and vertical in use and the top and bottom members extend between the two side members. The appliance includes at least one tab, the tab extending from a side member or the top or bottom members so that a front portion of the tab extends forward of a front edge of the chassis. The front portion of the tab has an aperture for fixing the tab to an inside of the cabinet or kitchen space with a fastener to fix the appliance within the cabinet or kitchen space.

This application is a non-provisional of 61/118,574, having a filing date of Nov. 28, 2008, which is hereby incorporated by reference in its entirety.

### FIELD OF THE INVENTION

The present invention relates to an appliance. More specifically, the present invention relates to installation features of an appliance for installing an appliance within a kitchen space.

### BACK GROUND OF THE INVENTION

An appliance such as a dishwasher or refrigerator is installed within a kitchen space or cabinet space of a kitchen.

An appliance is typically fixed within a kitchen or cabinet space, to hold the appliance securely in place. If an appliance is not fixed to the floor or cabinetry in some way or counterbalanced, when the appliance is opened, particularly if it is a drawer style appliance or it has a horizontally hinged door, the appliance tends to tilt about its front bottom edge. This problem is particularly severe when a heavy load, such as a drawer full of crockery, is pulled out of the appliance. An example of a drawer style appliance is Fisher and Paykel's Dishdrawer™ dishwasher.

One known solution to this problem is to provide a counterbalance in the appliance. A block of concrete is used to weigh the appliance down and prevent tilting.

Another solution to this problem is to fix the appliance in position. In the past, this has been achieved by fastening the appliance to the floor, worktop or to the surrounding cabinetry. However, each of these solutions has drawbacks. Screwing cleats into the floor into which the appliance slides damages the floor and requires accurate drilling of holes into various types of floor surface. To fix the appliance to the surrounding cabinetry or worktop, fasteners such as screws fix the appliance through holes in the sides of the appliance to the sides of the cabinet defining the cabinet space. This requires access to the interior of the appliance and usually requires partial disassembly of the appliance.

To access the inside of a drawer style appliance, it is necessary to remove at least one drawer from the appliance. A typical installation procedure for a drawer style appliance involves removal of the drawer from the appliance chassis to allow access to the inside of the appliance chassis. Once access to the inside of the chassis is gained, the chassis is fixed to the cabinet with fasteners through holes in the side of the chassis. With the chassis fixed in place within the cabinet space, the drawer is reassembled within the appliance chassis.

Dismantling the drawer from an appliance to allow installation within a cabinet or kitchen space can lead to reliability issues should the drawer or connections be damaged or incorrectly reassembled within the appliance.

The incorrect installation of an appliance can lead to, and is a common cause for operational faults. Accordingly it is an object of the present invention to provide an improved appliance or to at least provide the public with a useful choice.

### SUMMARY OF THE INVENTION

In a first aspect, the present invention broadly consists in an appliance comprising:
a chassis with two side members, a top member and a bottom member, the side members spaced apart and parallel and vertical in use, the top and bottom members extending between the two side members,
at least one tab, the tab extending from a said side member or the top or bottom members so that a front portion of the tab extends forward of a front edge of the chassis, the front portion having an aperture for fixing the tab to an inside of the kitchen or cabinet space with a fastener to fix the appliance within the kitchen or cabinet space.

Preferably the appliance includes a trim, the trim attached to and extending around at least a portion of the perimeter of the front edge of the chassis, the trim forming a forward facing surface adjacent a front opening of the appliance, the front opening providing access to the inside of the appliance, the forward facing surface being forward of the at least one tab.

Preferably the trim has a body and a resilient cover portion, the body being fixed to the chassis, the resilient cover portion being attached to a front facing outer edge portion of the body to be substantially in plane with the front opening and substantially conceal the body.

Preferably the body has a cavity corresponding with the aperture of the at least one tab, the cavity located in a front surface of the body beneath the resilient cover portion, the cavity extending through a side of the trim to provide an access way from the front surface of the body for a fastener to be located through the aperture, the resilient cover portion substantially concealing the cavity.

Preferably the cavity is inclined, the cavity having a depth increasing towards the tab to allow a fastener to locate through the aperture at an angle towards the rear of the appliance.

Preferably a plug is removably fitted to the cavity to substantially fill the cavity and conceal the fastener, the resilient cover portion substantially concealing the plug.

Preferably the plug includes an at least one rearwardly extending peg to fit within a corresponding at least one hole in the cavity.

Preferably the resilient cover portion is a seal for sealing against a door of the appliance when the door is in a closed position to close the front opening of the appliance.

Preferably the trim includes a resilient wing portion extending from the body adjacent a rear edge portion of the body, the resilient wing portion extending around at least a portion of the perimeter of the front edge of the chassis, the resilient wing portion adapted to substantially conceal a gap between the appliance and a wall of the cabinet.

Preferably the chassis has a flange extending around at least a portion of the perimeter of the front edge of the chassis, the flange being substantially parallel with the front opening of the appliance, and
the body includes a plurality of rearwardly extending pegs to fit within a plurality of corresponding holes in the flange to fix the body to the front of the chassis.

Preferably the body is rigid plastic and the resilient cover portion is overmoulded with the body.

Preferably the body is rigid plastic and the resilient cover portion and resilient wing portion are overmoulded with the body, the resilient cover portion and resilient wing portion being a continuous moulding.

Preferably the plug is made from a resilient material.

Preferably the at least one tab has at least one leg and the chassis has a corresponding at least one opening for receiving the leg to connect the tab to the chassis.

Preferably the tab has a shoulder to bear against a first edge of the opening, the shoulder defining the position of the tab when the tab is connected to the chassis.

Preferably the tab includes a biased locking member to retain the tab in a connected position.

Preferably the locking member is a biased tag formed in the at least one leg, the biased tag bearing against a second edge of the opening.

Preferably the tab is removably connectable to the chassis.

Preferably the appliance includes at least a first tab and a second tab connected to a side member or the top or bottom member, the at least one leg of the first tab being connected to the chassis at a first angle and the at least one leg of the second tab being connected to the chassis at a second angle, the first and second angles being oppositely opposed.

Preferably the tab is made from sheet metal.

Preferably the at least one tab is integrally formed with a said side member, the top member or the bottom member.

Preferably the at least one tab is cut from a said side member, the top member or the bottom member, and folded about a bend axis so that the front portion of the tab extends forwards of the front edge of the chassis.

Preferably the appliance includes at least a first tab and a second tab cut from a said side member, the top member or the bottom member, the first tab being folded about a first bend axis at a first angle, and the second tab being folded about a second bend axis at a second angle, the first and second angles being oppositely opposed.

Preferably the tab is connected to the chassis via an at least one connection point, the at least one connection point being spaced a distance from the front edge of the chassis.

Preferably the at least one connection point is spaced a maximum distance of approximately 20 mm from the front edge of the chassis.

Preferably the chassis has a substantially rectangular front opening and the appliance includes four tabs, the tabs extending from the chassis adjacent a corresponding corner of the front opening.

Preferably diagonally opposite tabs are the same, one tab being oriented upside down with respect to a diagonally opposite tab.

Preferably the appliance is a drawer style appliance including a drawer adapted to move between an open position and a closed position, and wherein the aperture of the at least one tab is accessible when the drawer is in the open position.

In a second aspect the present invention broadly consists in a method for securing an appliance within a kitchen or cabinet space, the appliance having a front opening for accessing the inside of the appliance and a door for closing the front opening, the method comprising the steps of:
i) fitting at least one tab to a side of the appliance adjacent a front of the appliance, so that a front portion of the tab extends forward of a chassis of the appliance, the front portion including an aperture,
ii) positioning the appliance within a kitchen or cabinet space,
iii) with the door in an open position, fixing the appliance within the kitchen or cabinet space with a fastener via the aperture in the at least one tab.

Preferably step iii) includes steps:
iii)(a) with the door in an open position, flexing a flexible cover or door seal fitted to the front of the chassis away from a front edge of the front opening to gain access to the aperture,
iii)(b) fixing the appliance within the kitchen or cabinet space with at least one fastener via the aperture in each said tab,
iii)(c) concealing the fastener with the flexible cover or door seal.

Preferably step iii)(c) includes steps:
iii)(c)(i) fitting a plug to a cavity in a forwardly facing surface of the appliance through which the fastener is located to conceal the faster,
iii)(c)(ii) concealing the plug with the flexible cover or door seal.

Preferably step (i) includes fitting a tab adjacent to each of the four corners of a front of the appliance.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a part sectional view of a prior art appliance.

FIG. 2 is a part sectional view of an appliance incorporating the present invention.

FIG. 3 is an exploded view of a front corner of an appliance incorporating the present invention.

FIG. 4 is an exploded view of the front corner the appliance of FIG. 3 viewed from the rear.

FIG. 5A is a view of a front corner of a chassis of an appliance incorporating the present invention.

FIG. 5B is a cross sectional view of an opening in the side of the chassis, viewed on arrows AA in FIG. 5A

FIG. 6 is a side view of a tab of the present invention for securing an appliance incorporating the present invention into a cabinet.

FIG. 7 is the view of a front top corner of an appliance incorporating the present invention and installed within a cabinet.

FIG. 8 is the view of FIG. 7 but with section of a door seal flexed outwards to show a cavity located behind the door seal.

FIG. 9 is the view of FIG. 8 but with a plug fitted to the cavity behind the door seal.

FIG. 10 is the exploded view of FIG. 3 but with a section of a cover or seal portion of the appliance removed to show a cavity behind the cove or seal.

FIG. 11 is a partial view of the front of a chassis of an appliance incorporating an alternative embodiment of the present invention.

### DETAILED DESCRIPTION

The present invention provides an arrangement for installing an appliance within a cabinet or kitchen space, for example under a workbench between two cabinets. The present invention is particularly useful for drawer style appliances. Drawer style appliances, such as Fisher and Paykel's Dishdrawer™ dishwasher include a drawer that slides within an outer cabinet or chassis. The front of the drawer includes a panel which acts as a door to close off the appliance when the drawer is in a closed position. However, the present invention may also be incorporated in an appliance with a front opening panel or door, such as a door that pivots about a pivot axis adjacent a lower front portion of the appliance. The present invention may be incorporated into an ‘integrated appliance’ that fits within a cabinet space. Alternatively, the present invention may be incorporated into a freestanding or ‘pre-finished appliance’ that fits in a kitchen space between two cabinets and supported by a floor surface. The present invention will be described generally in relation to a drawer style appliance.

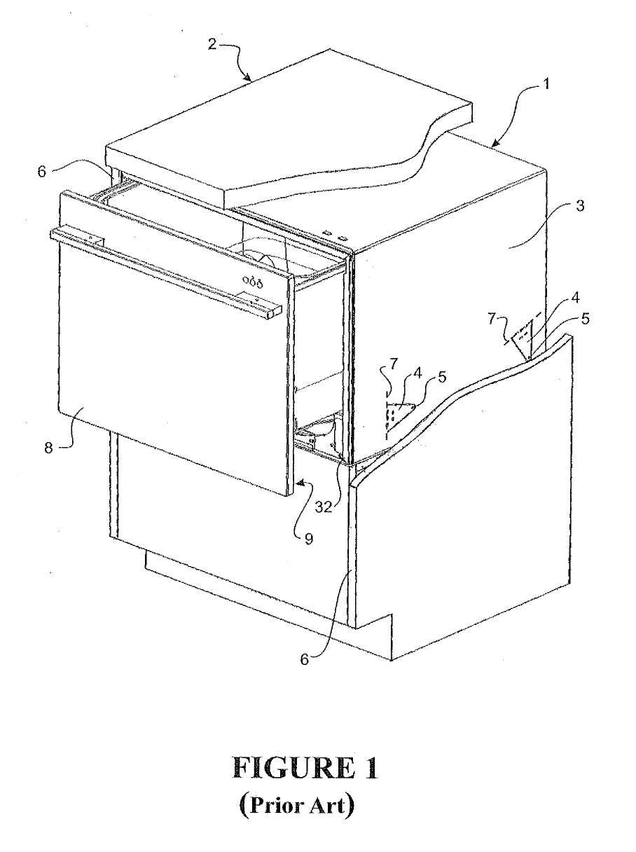

FIG. 1 shows a prior art drawer style appliance 1, located with a cabinet 2. The cabinet is shown partially cut away to reveal a side of the appliance chassis 3. The chassis is securely fixed within the cabinet space by fasteners such as screws (not shown) fixed through holes 5 in the sides of the chassis into the sides of the cabinet 6. The fixing holes 5 may be located within a flap 4. Flap 4 is cut in the side of the chassis to allow the flap 4 to bend outwards from the plane of the side of the chassis. Each flap is cut such that the flap may bend about an axis 7. Hole 4 is spaced from axis 7 so that with bending of flap 4 outwards from the side of the chassis, hole 4 may be positioned against the inside of the cabinet wall 6. Flaps 4 allow for clearance between the chassis side and the wall of the cabinet to be taken up. To gain access to fastener holes 4, the drawer 8 must be removed from the appliance. Once the chassis is securely fixed within the cabinet, the drawer must be reinstalled within the chassis.

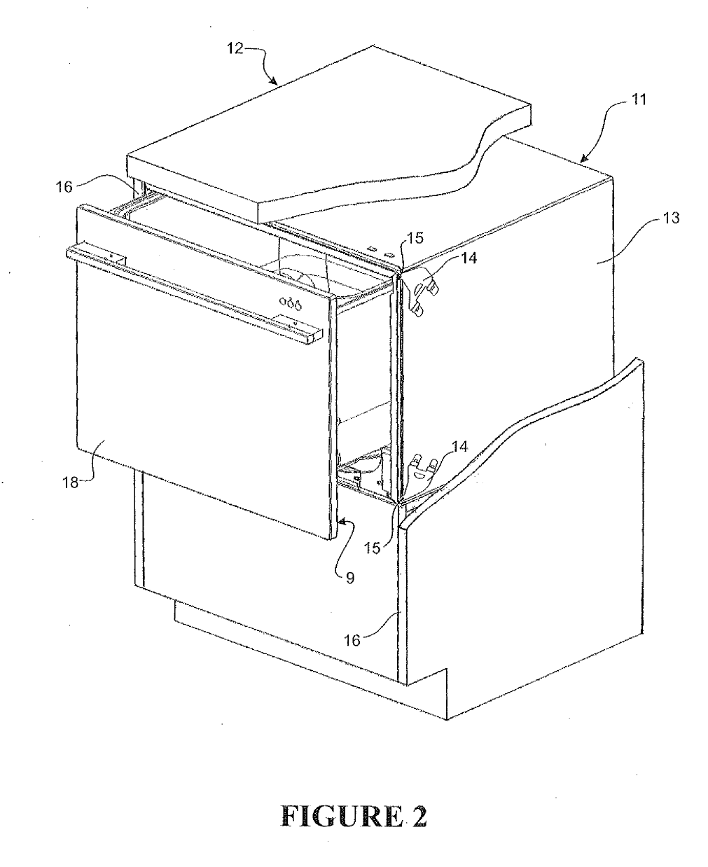

FIG. 2 is a partially sectioned view of an appliance 11 incorporating the present invention. The appliance includes at least one fixing tab 14. The fixing tab 14 is located adjacent a front edge of the chassis 13 and extends forward of the front edge of the chassis 13. The tab 14 provides an aperture or fixing hole 15. The fixing hole 15 is located forward of the front edge of the chassis. The tab 14 provides aperture 15 for fixing the tab to a side 16 of the cabinet 12 with a fastener to fix the appliance within the cabinet.

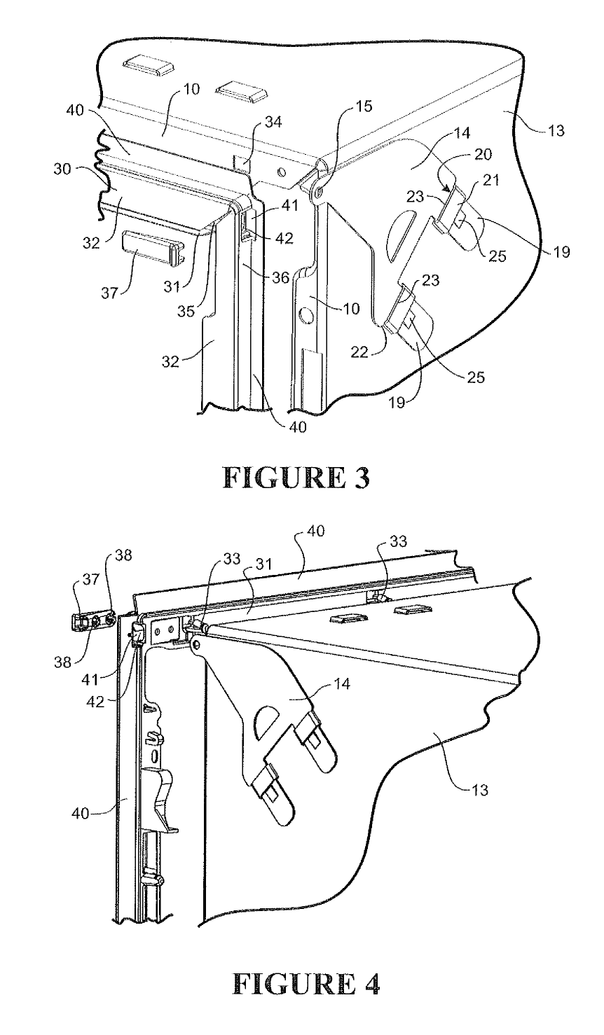

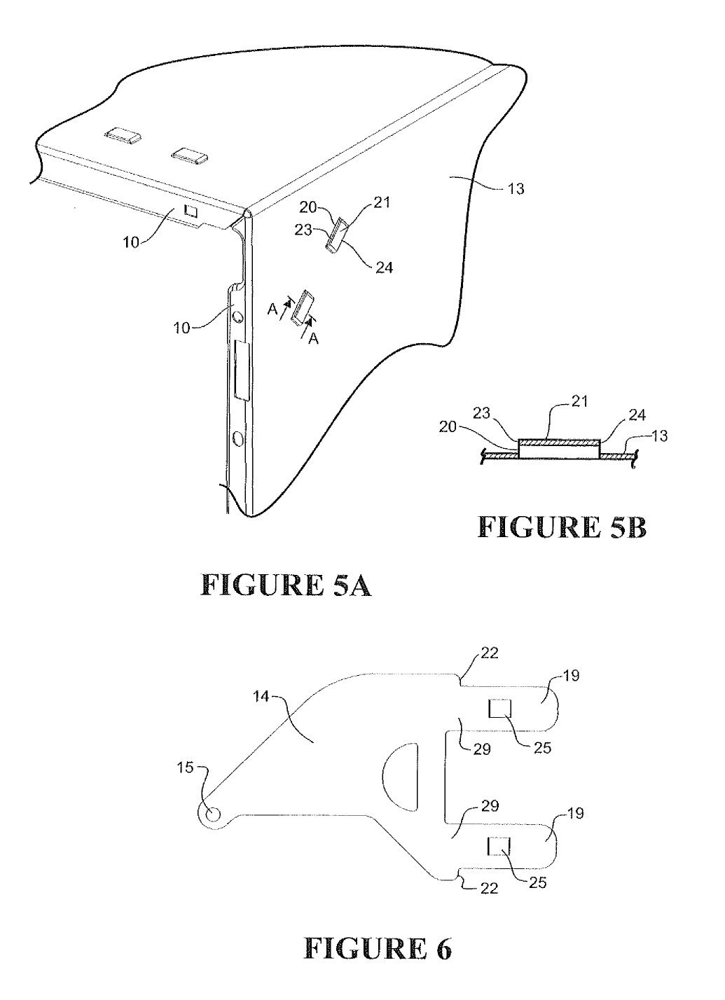

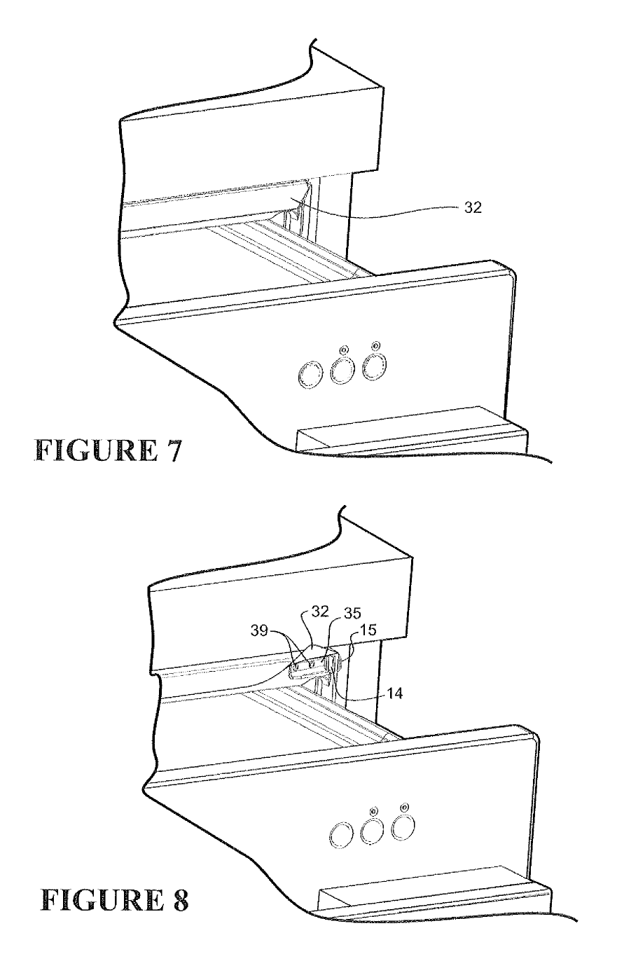

Referring to FIG. 3, in the preferred embodiment the tab 14 is fitted or connected to the side of the chassis 13. Tab 14 has at least one leg 19. Leg 19 is inserted into an opening 20 in the side of the chassis. In the preferred embodiment, the opening is created by a strap or lance of material 21 formed in the side of the chassis 13. The leg 19 passes into the opening between the strap 21 and the side of the chassis 13, as best shown in FIGS. 5A and 513. The tab has a shoulder 22. Shoulder 22 bears against an edge 23 of the opening 20 to define the position of the tab when connected to the chassis.

The leg 19 extends beyond the strap 21. The leg preferably has a tag 25 formed from the material of leg 19. Tag 25 acts as a biased locking member. Once leg 19 is fully inserted into opening 20, shoulder 22 bears against forwardly facing edge 23 and locking tag 25 bears against a rearward facing edge 24 of the strap 21, to retain the tab in a connected position. Tab 14 may be released from the side of the chassis by depressing tag 25 to clear the rearward facing edge 24. The tab is removeably connectable to the chassis. Preferably the tab is made from sheet metal.

Strap 21 is preferably formed by a cutting and pressing operation to form strap 21 from the material of the side of the chassis. Alternatively, strap 21 may be formed separately and fixed to the side of the chassis, for example, by welding.

Preferably tab 14 has two legs 19 corresponding with two openings 20 formed in the side of the chassis.

Preferably two tabs are fitted to a side of the chassis. Preferably one tab is located adjacent an upper front corner of the chassis and the other tab located adjacent a lower front corner of the chassis. Preferably the legs 19 of the tab are oriented at an angle relative to front vertical plane or upper horizontal plane of the chassis. Preferably the upper tab and the lower tab are oriented at opposite angles to assist in bracing the appliance within the cabinet space. For example, the legs of the upper tab may be angled downwards from the front of the appliance, and the legs of the lower tab may be angled upwards from the front of the appliance. Up and down movement or forward and backward movement of the appliance within the cabinet is resisted by the oppositely opposed angled tabs 14.

In an alternative embodiment of the present invention, the tabs may be integrally formed with the chassis. For example, tabs 14 may be cut from a side member and folded about a bend axis 17 as shown in FIG. 11. With reference to FIG. 11, tab 14 may be cut from the side of the chassis along solid lines 44. Dashed lines 45 indicate the position of tab 14 once tab has been folded about fold axis 17. Once tab 14 has been folded about fold axis 17, a front portion of the tab, including the fastener aperture 15, is positioned forward of the front edge of the chassis 13.

The bend axis 17 of the tab is oriented at an angle relative to front vertical plane or upper horizontal plane of the chassis. Preferably two tabs are fitted to a side of the chassis. Preferably one tab is located adjacent an upper front corner of the chassis and the other tab located adjacent a lower front corner of the chassis. Preferably the bend axis for the upper tab and the bend axis for the lower tab are oriented at opposite angles. For example, the bend axis of the upper tab may be angled so that the upper tab folds upwards towards the upper front corner, and the bend axis of the lower tab angled so that the lower tab folds downwards towards the lower front corner of the chassis.

In further alternative embodiments, the tab 14 may be fixed to the chassis by welding, riveting, bolting or other fixing means. However, providing separate tabs 14 in accordance with the preferred embodiment of the present invention allows the fastener holes 15 to be located forward of the front edge of the chassis without complication of the chassis manufacturing process.

With reference to FIG. 6, the area 29 of the tab between the shoulder 22 and the locking tag 25 may be described as a connection point 29 that engages with opening 20 and strap 21 of the chassis. Connection points 29 are spaced a distance from the front edge of the chassis. Similarly, in the alternative embodiment of FIG. 11, tabs 14 are connected to the chassis along the bend axis 17. The connection point, or bend axis 17, is spaced a distance from the front edge of the chassis.

Spacing the connection points 29, 17 a distance from the chassis front edge, and therefore the front portion and fastener hole of the tab, allows the front portion of the tab to flex outwards from the chassis to take up small clearances between the chassis and the cabinet side walls. This flexibility assists with the installation of the appliance compared to if fastening points 15 are integrally formed or attached to the chassis at the front edge of the chassis.

Also, by spacing the connection points 29, 17 from the chassis front edge and fastening point 15, the strength of the chassis at the chassis front edge is maintained, as there are no cuts or material removed from the chassis front edge. For example, in a further alternative embodiment, flaps described as item 4 in relation to FIG. 1 could be formed in the chassis side walls at the front edge of the chassis. In this alternative embodiment, to achieve tabs that extend forward of the front edge of the chassis, the front portion of the flap would need to be formed from a portion of the front flange 10 of the chassis aligned in plane with the side of the chassis. However, such flaps formed at the front edge would be detrimental to the structural strength of the chassis.

Preferably the distance between the connection points 29, 17 and the fastener hole 15 is a maximum of approximately 20 min. For larger distances, the flex of the tabs may result in a less secure attachment of the appliance within the kitchen or cabinet space.

Preferably four tabs are fitted to the chassis. The chassis has a generally rectangular shaped front opening. Preferably each tab is located adjacent a corresponding corner of the front opening. Preferably tabs located diagonally opposite one another across the front opening of the chassis are identical. For example, the tab located at the top right corner of the chassis opening may be connected to the chassis at the bottom left corner of the chassis, by orienting the tab upside down relative to the orientation at the top right corner.

In the preferred embodiment, the tabs 14 are connected to the sides of the chassis 13. Alternatively, the tabs may be connected to the top member or the bottom member of the chassis, or any combination of tabs being connected to or formed in the sides, top or bottom of the chassis. For example, two tabs may be attached to the top member and two tabs may be attached to the bottom member, each tab adjacent a front corner of the chassis. Alternatively, one tab may be attached to a side member adjacent a top corner of the chassis, and a second tab may be attached to the other side member adjacent the other top corner of the chassis.

The appliance preferably includes a trim 30. Trim 30 is attached to a front edge of the chassis and extends around at least a portion of the perimeter of the front edge of the chassis. The trim forms a forward facing surface adjacent a front opening of the appliance. The front opening provides access to the inside of the appliance.

The trim comprises at least a body 31 and a resilient cover portion 32. The cover portion preferably acts as a seal for sealing against a rear surface 9 of a door or front panel of the appliance, as shown in FIG. 2. The door or front panel of the appliance may be attached to the front of the drawer of a drawer style appliance. Alternatively the door or front panel may be pivotally attached to the appliance. The seal or cover 32 is attached to a front facing outer edge portion of the body to be substantially in plane with the front opening of the appliance. The cover or seal 32 substantially conceals the body 31.

Preferably the trim body 31 is made from a rigid plastic such as ABS or other similar rigid plastic. Preferably the resilient cover portion 32 is a thermoplastic elastomer.

Preferably the resilient cover portion is overmoulded onto the rigid plastic body to form an integrated unit.

The chassis preferably includes a flange 10 extending around at least a portion of the perimeter of the front edge of the chassis. The flange is preferably formed from the chassis material by bending a front edge region of the sides and top and bottom sections of the chassis to be substantially parallel to the front opening of the appliance. The trim body 31 is preferably attached to the chassis with pegs 33 extending rearward from the body, the pegs being located in holes 34 in the flange 10 to fix the body to the front of the chassis. Pegs 33 may include a shoulder which locates behind the flange to hold the trim in place on the front on the chassis. Some pegs 33 may not include a shoulder and may assist with the location of the trim onto the front of the chassis.

The trim body includes at least one cavity 35 corresponding with the hole 15 of the at least one tab 14. The cavity is located in a front surface of the body beneath the resilient cover or seal portion 32. The cavity extends through a side 36 of the trim 30 to provide an access way from the front surface of the body for a fastener to be located through the tab fixing hole 15. The resilient cover substantially conceals the cavity 35.

Preferably the cavity is inclined towards the tab aperture 15 to allow a fastener to be located through the aperture 15 at an angle towards the rear of the appliance. The depth of the cavity is inclined, the depth increasing towards the tab. The inclined cavity allows a tool such as a screw driver to be used to install the fastener. By providing an angled cavity or pathway for the fastener, the tool does not interfere with the front of the appliance during installation.

Preferably a plug 37 is removeably fitted to the cavity 35 to substantially fill the cavity and conceal the fastener. Once fitted, the seal or cover 32 substantially conceals the plug. Preferably the plug includes at least one peg 38 extending rearward from the plug. The peg 38 fits into a corresponding hole 39 located in the cavity 35 of the body 31, to retain the plug 38 within cavity 35.

Preferably the plug is formed of resilient material, such as a thermo plastic elastomer. Preferably the plug has a higher hardness compared to the resilient seal material 32.

Preferably the trim includes a resilient wing portion 40. Wing portion 40 extends from the body adjacent a rear edge portion of the body. The wing extends around at least a portion of the perimeter of the front edge of the chassis. Once installed within the cabinet 2, the wing provides a means to conceal a gap between the chassis and the walls of the cabinet, where there is a relatively loose fit between the chassis and the cabinet. Where the fit between the cabinet and the chassis is tight, the wing is resilient enough to flex inwards towards the front of the appliance and away from the side of the cabinet.

The wing portion 40 extends from the body adjacent a rear edge portion of the body. A hole or slot 41 is provided through the wing portion adjacent to the tab 14 to allow the front portion of the tab to extend through the wing portion to align aperture 15 with the corresponding cavity 35. Slot 41 and cavity 35 communicate via a hole 42 in the side 36 of the trim 30.

Preferably the resilient wing portion is overmoulded with the rigid body. Preferably the resilient cover portion and the resilient wing portion are a continuous moulding.

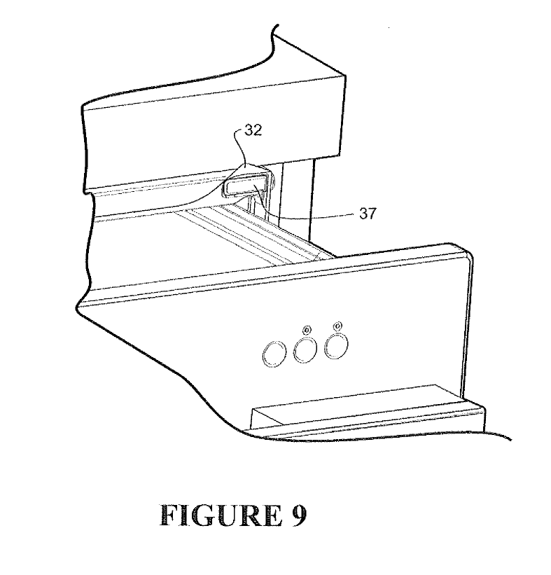

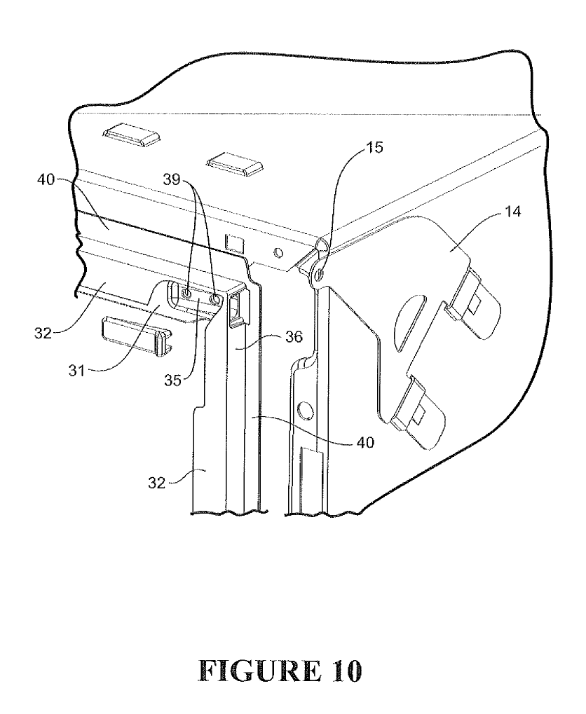

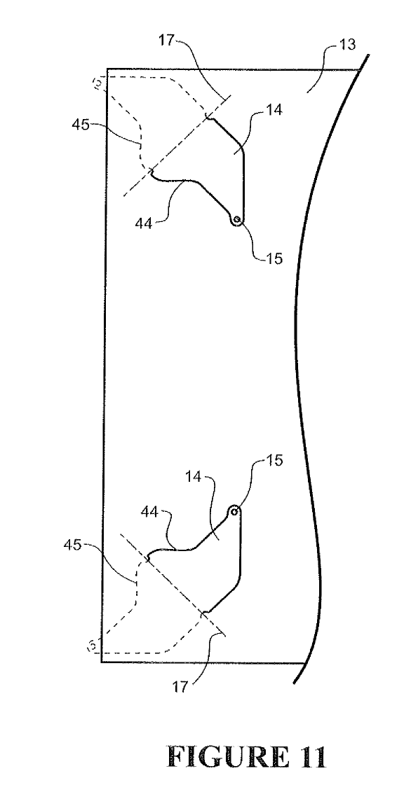

Tabs 14 extending forward of the front edge of the chassis 13 allow the appliance to be fixed to the cabinet without a requirement to dismantle the appliance by removing the drawer 18 from the appliance 11. Fixing holes 15 are accessible at the front of the appliance once drawer 18 has been pulled outwards from a closed position to an opened or partially open position in which the drawer is intended to be in during normal use of the appliance. The present invention provides the means for locating and fixing an appliance inside a cabinet using only features that are placed on accessible areas of the appliance. The fixing holes 15 are easily located once the seal or cover portion 32 is flexed outwardly, as shown in FIGS. 8 and 9. There is no requirement to dismantle the drawer from the appliance during installation of the appliance into the cabinet. This potentially reduces operational faults caused by the incorrect installation or reassembly of the drawer.

The foregoing description of the invention includes preferred forms thereof. Modifications may be made thereto without departing from the scope of the invention as defined by the accompanying provisional claims.

1. An appliance adapted to be installed within a kitchen or cabinet space comprising:
a chassis with two side members, a top member and a bottom member, the side members spaced apart and parallel and vertical in use, the top and bottom members extending between the two side members,
at least one tab, the tab extending from a said side member or the top or bottom members so that a front portion of the tab extends forward of a front edge of the chassis, the front portion having an aperture for fixing the tab to an inside of the kitchen or cabinet space with a fastener to fix the appliance within the kitchen or cabinet space.

2. The appliance as claimed in claim 1 wherein the appliance includes a trim, the trim attached to and extending around at least a portion of the perimeter of the front edge of the chassis, the trim forming a forward facing surface adjacent a front opening of the appliance, the front opening providing access to the inside of the appliance, the forward facing surface being forward of the at least one tab.

3. The appliance as claimed in claim 2 wherein the trim has a body and a resilient cover portion, the body being fixed to the chassis, the resilient cover portion being attached to a front facing outer edge portion of the body to be substantially in plane with the front opening and substantially conceal the body.

4. The appliance as claimed in claim 3 wherein the body has a cavity corresponding with the aperture of the at least one tab, the cavity located in a front surface of the body beneath the resilient cover portion, the cavity extending through a side of the trim to provide an access way from the front surface of the body for a fastener to be located through the aperture, the resilient cover portion substantially concealing the cavity.

5. The appliance as claimed in claim 4 wherein the cavity is inclined, the cavity having a depth increasing towards the tab to allow a fastener to locate through the aperture at an angle towards the rear of the appliance.

6. The appliance as claimed in claim 4 wherein a plug is removably fitted to the cavity to substantially fill the cavity and conceal the fastener, the resilient cover portion substantially concealing the plug.

7. The appliance as claimed in claim 6 wherein the plug includes an at least one rearwardly extending peg to fit within a corresponding at least one hole in the cavity.

8. The appliance as claimed in claim 3 wherein the resilient cover portion is a seal for sealing against a door of the appliance when the door is in a closed position to close the front opening of the appliance.

9. The appliance as claimed in claim 2 wherein the trim includes a resilient wing portion extending from the body adjacent a rear edge portion of the body, the resilient wing portion extending around at least a portion of the perimeter of the front edge of the chassis, the resilient wing portion adapted to substantially conceal a gap between the appliance and a wall of the cabinet.

10. The appliance as claimed in claim 3 wherein the chassis has a flange extending around at least a portion of the perimeter of the front edge of the chassis, the flange being substantially parallel with the front opening of the appliance, and
the body includes a plurality of rearwardly extending pegs to fit within a plurality of corresponding holes in the flange to fix the body to the front of the chassis.

11. The appliance as claimed in claim 3 wherein the body is rigid plastic and the resilient cover portion is overmoulded with the body.

12. The appliance as claimed in claim 6 wherein the plug is made from a resilient material.

13. The appliance as claimed in claim 1 wherein the at least one tab has at least one leg and the chassis has a corresponding at least one opening for receiving the leg to connect the tab to the chassis.

14. The appliance as claimed in claim 13 wherein the tab has a shoulder to bear against a first edge of the opening, the shoulder defining the position of the tab when the tab is connected to the chassis.

15. The appliance as claimed in claim 13 wherein the tab includes a biased locking member to retain the tab in a connected position.

16. The appliance as claimed in claim 15 wherein the locking member is a biased tag formed in the at least one leg, the biased tag bearing against a second edge of the opening.

17. The appliance as claimed in claim 1 wherein the tab is removably connectable to the chassis.

18. The appliance as claimed in claim 13 wherein the appliance includes at least a first tab and a second tab connected to a side member or the top or bottom member, the at least one leg of the first tab being connected to the chassis at a first angle and the at least one leg of the second tab being connected to the chassis at a second angle, the first and second angles being oppositely opposed.

19. The appliance as claimed in claim 1 wherein the appliance is a drawer style appliance including a drawer adapted to move between an open position and a closed position, and wherein the aperture of the at least one tab is accessible when the drawer is in the open position.

20. A method for securing an appliance within a kitchen or cabinet space, the appliance having a front opening for accessing the inside of the appliance and a door for closing the front opening, the method comprising the steps of:
i) fitting at least one tab to a side of the appliance adjacent a front of the appliance, so that a front portion of the tab extends forward of a chassis of the appliance, the front portion including an aperture,
ii) positioning the appliance within a kitchen or cabinet space,
iii) with the door in an open position, fixing the appliance within the kitchen or cabinet space with a fastener via the aperture in the at least one tab.
